(19) United States
(12) Patent Application Publication
(10) Pub. No.: US 2011/0258165 A1
(43) Pub. Date: Oct. 20, 2011

(54) AUTOMATIC VERIFICATION SYSTEM FOR COMPUTER VIRUS VACCINE DATABASE AND METHOD THEREOF

(75) Inventors: Sang-Won JUNG, Seoul (KR); Jun-Seob KIM, Seoul (KR); Yong-Hyun KIM, Suwon (KR)

(73) Assignee: ESTsoft Corp., Seoul (KR)

(21) Appl. No.: 13/004,498

(22) Filed: Jan. 11, 2011

(30) Foreign Application Priority Data
Apr. 14, 2010 (KR) 2010-0034328

(51) Int. Cl. G06F 17/30

(52) U.S. Cl. 707/687; 707/E17.001

(57) ABSTRACT

The present invention relates to a method and system for automatically verifying a computer vaccine database and, more particularly, to a method and system for automatically verifying a computer vaccine database, which is capable of automatically verifying and modifying a vaccine database mounted on a vaccine engine so that a normal program is not recognized as viruses or malicious codes by storing information about the normal program in the vaccine database in order to remove computer viruses or malicious codes. According to the present invention, a file set of the latest vaccine database can be rapidly collected and processed, and the problems of a vaccine database file provided by a vendor can be checked in advance. Accordingly, there are advantages in that a function of alarming error conditions and a process of reporting error in a vaccine database update process can be automated.

### CROSS-REFERENCES TO RELATED APPLICATION

Priority to Korean patent application number 10-2010-0034328 filed on Apr. 14, 2010, the entire disclosure of which is incorporated by reference herein, is claimed.

### BACKGROUND OF THE INVENTION

1. Field of the Invention

The present invention relates to a method and system for automatically verifying a computer vaccine database and, more particularly, to a method and system for automatically verifying a computer vaccine database, which is capable of automatically verifying and modifying a vaccine database mounted on a vaccine engine so that a normal program is not recognized as viruses or malicious codes by storing information about the normal program in the vaccine database in order to remove computer viruses or malicious codes.

2. Background of the Related Art

A vaccine program for diagnosing and removing a computer virus, a worm, or an malicious code (hereinafter generally referred to as a ‘virus’) includes a vaccine database for storing information about viruses and a vaccine engine for classifying the viruses, operated according to specific patterns, with reference to the vaccine database and removing the viruses.

The vaccine program needs to consistently provide the update of the vaccine database for detecting and removing the latest viruses to vaccine users in order to cope with new viruses.

The vaccine database includes data constituting a virus file, behavior pattern analysis data of a program, or a specific data analysis value generated by an infected personal computer (PC). The vaccine program analyzes the infected PC on the basis of the data and removes viruses on the basis of the analysis result.

However, in case where viruses and a normal file are confused in a task of configuring data or there is error in the policy of classifying data in a process of configuring a vaccine database or in case where an external unmodifiable vaccine database including erroneous data is distributed to vaccine users, there is a problem in that a security accident due to misdiagnosis may occur. Many security accidents are actually generated because of the misdiagnosis of vaccine.

A method of a vaccine program detecting viruses is divided into a method of registering virus patterns and a method of detecting viruses using heuristic. The method of registering virus patterns may be divided into a method of manually analyzing viruses and registering virus patterns one by one and an automation method using an automated pattern analysis program.

If virus patterns are registered with a vaccine database using the manual method, there is an advantage in that viruses can be accurately checked, but erroneous data may be registered with the vaccine database because of a mistake of a virus analyzer or error in the determination of an analyzer. Furthermore, since there is a limit to the process of manually analyzing viruses one by one and registering virus patterns with the vaccine database, most vaccine companies automate the virus analyzer's analysis task using an automated pattern registration program. Here, in case where a policy of the pattern registration program is erroneously determined or a normal file not viruses is included in an automated virus storage unit, a normal application may be erroneously diagnosed as a virus.

Furthermore, in the method of detecting viruses using heuristic, whether an application is a virus is determined on the basis of a behavior pattern of the application according to an automated policy. In case where the heuristic detection policy is erroneous or the behavior of a normal application is similar to that of a virus, the normal application may be erroneously diagnosed as a virus.

In order to prepare for such various false possibilities, a false positive test for a vaccine database is required before the vaccine database is updated. It is not easy to take preventive measures with consideration taken of various target applications increasing in geometric progression and vaccine engines and vaccine applications needed to be consistently updated. In particular, although viruses are detected in advance, it takes a lot of time to verify a modified vaccine database again, hindering updating the vaccine database which requires real-time measures as an important factor. In particular, this problem is difficult to solve in the latest vaccine trend in which one vaccine operates a plurality of engines.

In the existing white list method, detection is performed using a vaccine database in the state in which a specific file set is maintained. If, as a result of the detection, there is error, only exclusion processing is performed. Furthermore, the entire process from detection to modification is not an automated method, but a manual task method of performing a next task while checking error.

### SUMMARY OF THE INVENTION

Accordingly, the present invention has been made in view of the above problems occurring in the prior art, and it is an object of the present invention to provide a method and system for automatically verifying a computer vaccine database, which are capable of automatically collecting and verifying the vaccine database in order to correct error of the vaccine database rapidly and accurately and distributing the verified vaccine database to users.

It is another object of the present invention to provide a method and system for automatically verifying a computer vaccine database, which are capable of always distributing the latest vaccine database by preventing the delay of an update of a vaccine database and making a verification cycle of the vaccine database shorter than a distribution cycle of the vaccine program.

To achieve the above objects, according to an embodiment of the present invention, there is provided a verification system for automatically verifying error of a vaccine database for storing information about a computer virus, a worm, or a malicious code (hereinafter generally referred to as a ‘virus’), comprising a first database storage unit for collecting a vaccine database to be verified and storing the collected vaccine database; a first engine storage unit for collecting a vaccine engine to be verified and storing the collected vaccine engine; a file set storage unit for collecting a program to be registered so that the program is not mistaken as a virus and storing the program; a verification unit for mounting the vaccine database, stored in the first database storage unit, on the vaccine engine stored in the first engine storage unit, testing the program stored in the file set storage unit, and determining whether the program is recognized as a virus on the basis of the test; and an exclusion processing unit for, if, as a result of the determination, the program is determined to be recognized as a virus, modifying the vaccine database mounted on the vaccine engine so that the program is not recognized as a virus.

The verification system further comprises a second database storage unit for, as a result of the determination, the program is determined not to be recognized as a virus, storing the verified vaccine database and a second engine storage unit for, as a result of the determination, the program is determined not to be recognized as a virus, storing the verified vaccine engine.]

The program stored in the file set storage unit is any one of a program having a large number of downloads in a file download site, a game program having a larger number of users, a business application being used in a company connected to the verification system, and an application requested for a check into error from the verification system.

The verification system further comprises a distribution processing unit for distributing the vaccine database and the vaccine engine, verified by the verification unit and respectively stored in the second database storage unit and the second engine storage unit, through an Internet every predetermined time and cycle.

The verification unit constantly maintains a time taken for a verification process by increasing or decreasing a number of verification machines, used in a process of verifying the vaccine database, according to the time taken for the verification process.

According to another embodiment of the present invention, there is provided a verification method of automatically verifying error of a vaccine database for storing information about a computer virus, a worm, or a malicious code (hereinafter generally referred to as a ‘virus’), comprising a first step of collecting a vaccine database and a vaccine engine to be verified and storing the vaccine database and the vaccine engine in a first database storage unit and a first engine storage unit, respectively; a second step of collecting a program to be registered so that the program is not mistaken as a virus and storing the collected program in a file set storage unit; a third step of a verification unit mounting the vaccine database, stored in the first database storage unit, on the vaccine engine stored in the first engine storage unit, testing the program stored in the file set storage unit, and determining whether the program is recognized as a virus on the basis of the test; and a fourth step of, if, as a result of the determination, the program is determined to be recognized as a virus, an exclusion processing unit modifying the vaccine database mounted on the vaccine engine so that the program is not recognized as a virus.

The verification method further comprises a fifth step of, as a result of the determination, the program is determined not to be recognized as a virus, storing the verified vaccine database in a second database storage unit and a sixth step of, as a result of the determination, the program is determined not to be recognized as a virus, storing the verified vaccine engine in a second engine storage unit.

The program stored in the file set storage unit is any one of a program having a large number of downloads in a file download site, a game program having a larger number of users, a business application being used in a company connected to the verification system, and an application requested for a check into error from the verification method.

The verification method further comprises a seventh step of a distribution processing unit distributing the vaccine database and the vaccine engine, verified by the verification unit and respectively stored in the second database storage unit and the second engine storage unit, through an Internet every predetermined time and cycle.

The verification unit verifies whether the program is mistaken as a virus every cycle, and a verification cycle of the verification unit is shorter than a distribution cycle of the distribution processing unit.

### BRIEF DESCRIPTION OF THE DRAWINGS

Further objects and advantages of the invention can be more fully understood from the following detailed description taken in conjunction with the accompanying drawings in which:

FIG. 1 is a block diagram showing the construction of an automatic verification system according to an embodiment of the present invention;

FIG. 2 is a block diagram schematically showing the sequence of an automatic verification method;

FIG. 3 is a flowchart illustrating a database and engine collection process;

FIG. 4 is a flowchart illustrating a file set collection process;

FIG. 5 is a flowchart illustrating a verification process for a vaccine engine and a vaccine database; and

FIG. 6 is a flowchart illustrating an exclusion processing process for an engine or database with error.

<Description of reference numerals of
principal elements in the drawings>

| | |
|---|---|
| 100: verification system | 102: verification unit |
| 104: first database storage unit | |
| 106: first engine storage unit | |
| 108: file set storage unit | |
| 110: second database storage unit | |
| 112: second engine storage unit | |
| 114: exclusion processing unit | |
| 116: distribution processing unit | |

### DETAILED DESCRIPTION OF EMBODIMENTS

Hereinafter, a system and method for automatically verifying a computer vaccine database (hereinafter referred to as a ‘verification system’ and a ‘verification method’, respectively) according to embodiments of the present invention are described with reference to the accompanying drawings.

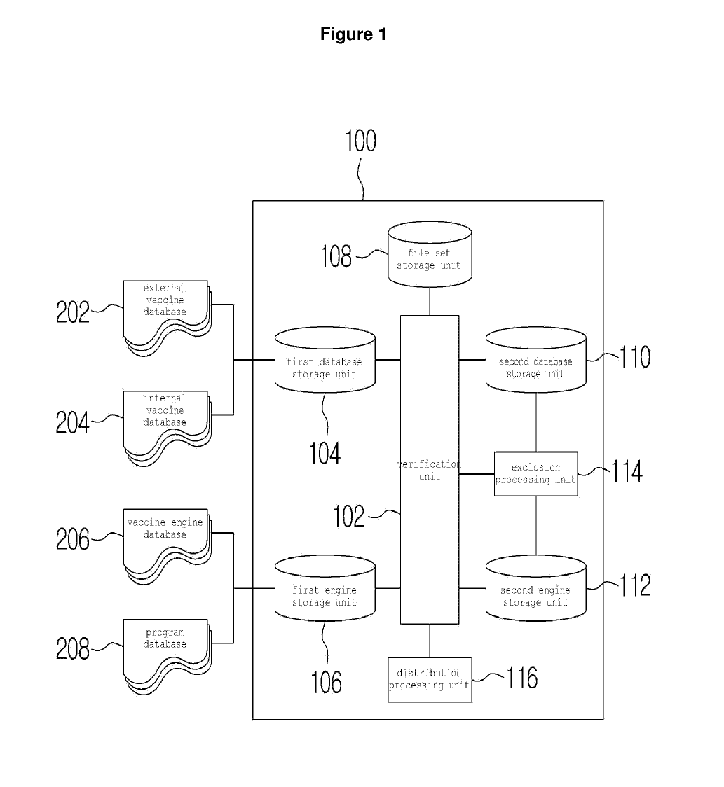

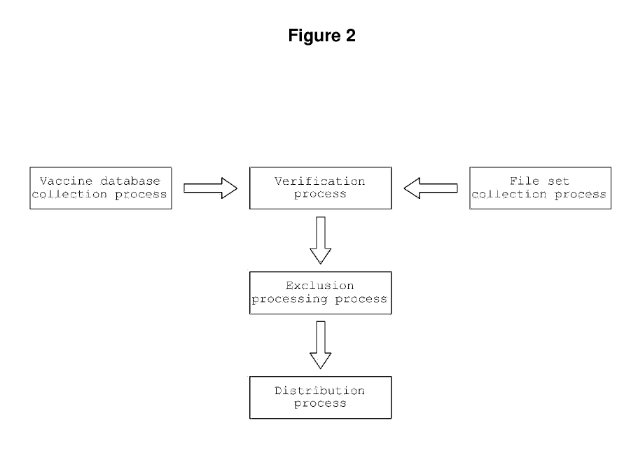

FIG. 1 is a block diagram showing the construction of the verification system according to an embodiment of the present invention, and FIG. 2 is a block diagram schematically showing the sequence of the verification method.

The verification system 100 of the present invention integrally performs processes of verifying a vaccine database in advance before distribution, selecting target data to be verified, collecting samples, dynamically configuring a verification machine, applying a flexible policy, and taking emergency measures against a distributed vaccine database.

More particularly, the verification system 100 executes a process of collecting the latest vaccine database, a process of collecting a target test file set, a verification process, an exclusion processing process, and a distribution process step by step. Each of the processes is separately executed without affecting other processes, and only storage units store data sets processed by the processes. The entire verification process is performed in such a manner that a data set which is a result processed by a previous process is transferred to a next process.

In each process, a task success report or a task failure report according to whether the task is successful or unsuccessful, and urgent alarm are performed. If a task is failed during each process, the person in charge of a corresponding problem in the process is informed of the failure through various notification methods, such as e-mail or SMS such that the person can rapidly recover failed parts in the process on the basis of a received failure report.

The distribution process policy is determined according to a service time that it takes to verify and distribute a vaccine database and the subject of update. The verification process is set to be executed in a shorter cycle than the distribution process so that it is executed more frequently than the distribution process. In this case, although a problem occurs during the verification process, a new verification task can be performed before a scheduled distribution time and so the distribution process can be normally performed. Accordingly, damage resulting from the failure of verification can be minimized.

A verification unit 102 functions to periodically check whether a normal program is mistaken as a virus with reference to an internal vaccine database 204 constructed by a security company which produces a vaccine program or an external vaccine database 202 constructed by external security companies.

The verification unit 102 has a vaccine database (that is, the subject of verification) mounted on a vaccine engine and may determine whether there is error in the vaccine database by executing a virus test for a normal program.

To this end, the verification system 100 is equipped with a first database storage unit 104 and the first engine storage unit 106 for storing a vaccine database and a vaccine engine, respectively, which have not yet been verified.

The first database storage unit 104 stores vaccine databases extracted from the external vaccine database 202 and the internal vaccine database 204. The first engine storage unit 106 stores a vaccine engine and a program respectively extracted from a vaccine engine database 206 and a program database 208.

The vaccine engine functions to detect a program showing a common virus characteristic while monitoring the program executed on a computer, analyze a behavior pattern of the detected program, and determine whether a virus has been penetrated into the detected program by comparing the behavior pattern and data stored in a vaccine database. The vaccine engine can accurately detect a virus by fetching virus data stored in a vaccine database and comparing the fetched virus data and a characteristic of a program being executed.

A file set storage unit 108 is a part for selecting and storing a program (that is, the subject of a test). The file set storage unit 108 collects and stores programs (that is, a program white list) which will be set so that they are not mistaken as viruses by a vaccine program.

The details of the white list program stored in the file set storage unit 108 are described later.

When a target test file set is collected, a file set of applications is not simply collected, but an application history task including meta information is performed by tracking the history of updates or versions of the applications. Accordingly, when erroneous detection is generated, recovery and countermeasure can be performed rapidly and accurately.

As described, if a target test file set is configured by collecting many applications from external systems and checking the history of updates and versions, problems arise in the space and verification time for maintaining the target test file set. When the target test file set is configured and stored in the file set storage unit 108, statistical data and meta information for all the existing target test file sets are generated in order to solve problems occurring because of the space and verification time problems and also make efficient the process.

In case where a new program is collected from an external system, the new program may be compared with a program stored in the file set storage unit 108 in order to determine whether the new program is already stored in the file set storage unit 108. In this case, redundant verification can be prevented. To this end, meta information, an MD5 hash value, etc. of the program stored in the file set storage unit 108 are stored and stored together with a program list. In case where a new program file set is collected, meta information and an MD5 hash value of the new program file set are generated and compared with those of a file set stored in the file set storage unit 108. Accordingly, whether the new program file set is stored in the file set storage unit 108 can be determined by comparing the meta information and MD5 hash value of the new program file set with those of the file set stored in the file set storage unit 108.

The technique in which meta information or a MD5 hash value of a program file are generated and stored in order to prevent redundant storage of a file is already known in the art, and a further description thereof is omitted.

A vaccine database that the verification unit 102 determines it to have error is stored in a second database storage unit 110. A vaccine engine and a program whose verification is successful are stored in a second engine storage unit 112.

If, as a result of a test performed by the verification unit 102, a vaccine engine having a specific vaccine database mounted thereon recognizes a program, stored in the file set storage unit 108, as a virus, it means that the corresponding vaccine database is erroneous. In this case, an exclusion processing unit 114 modifies the corresponding vaccine database so that the corresponding program is not mistaken as a virus.

The exclusion processing unit 114 is configured to send an error report to the administrator of the verification system 100 when error occurs and automatically modify a corresponding vaccine database.

A vaccine database and a vaccine engine which have been verified by a distribution processing unit 116 and the verification unit 102 and which are respectively stored in the second database storage unit 110 and the second engine storage unit 112 are distributed to users through the Internet at a predetermined time or cycle.

A verification process cycle performed by the verification unit 102 may be identical with a cycle in which the distribution processing unit 116 distributes a vaccine database. However, it is preferred that the verification cycle is shorter than the distribution cycle in order to secure the time taken for modification and distribution performed when error occurs in a verification process. For example, in case where the verification cycle is ⅓ or less of the distribution cycle, verification can be performed at least three times when distribution is performed once. Consequently, the time taken for error detection and correction can be secured.

Hereinafter, the operation of each process is described in detail.

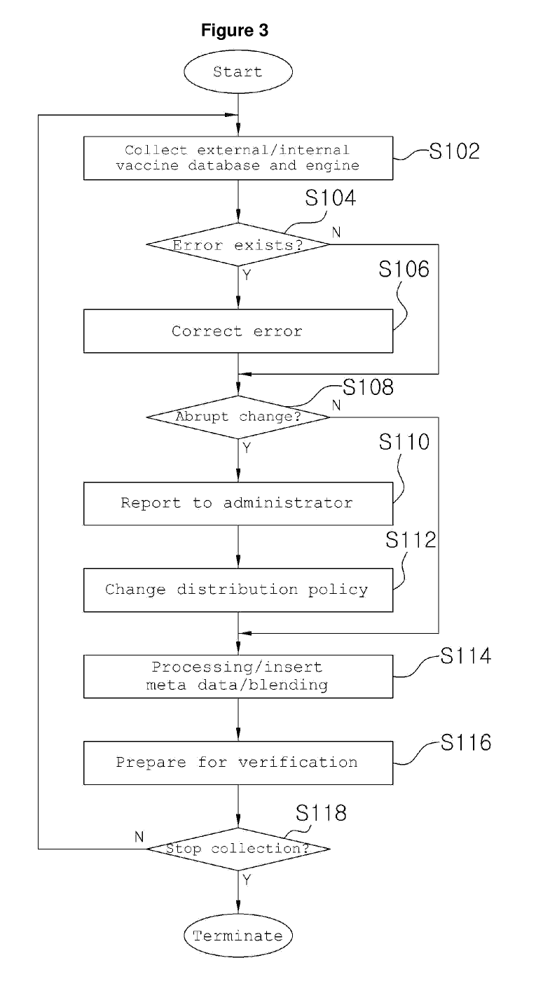

FIG. 3 is a flowchart illustrating the database and engine collection process.

In the collection process, a task of maintaining the latest vaccine-related files and processing the files so that they can be served is performed. In this process, the latest vaccine database and engine file set are maintained.

A vaccine database includes the internal vaccine database 204 configured internally and the external vaccine database 202 configured by external companies. In order to accurately deliver the latest vaccine database when it is required by a verification process, information, indicating whether the existing vaccine database is the latest vaccine database, is updated, and the latest vaccine database collected is stored in the first database storage unit 104 at step S102.

The vaccine engine database 206 and the program database 208 configured by a vaccine development team are also stored in the first engine storage unit 106 in order to verify whether an operation is normally performed.

Preparations are made such that a vaccine database and a vaccine engine stored in the first database storage unit 104 and the first engine storage unit 106 can pass the verification process. A task of processing the vaccine database and the vaccine engine so that they can experience the verification process is performed.

It is then determined whether there is a functional error in the vaccine database or vaccine engine at step S104. If, as a result of the determination, the functional error is determined to exist in the vaccine database or vaccine engine, the error is corrected and stored at step S106.

It is then determined whether there is an abrupt change when a virus is detected and cured at step S108. If, as a result of the determination at step S108, the abrupt change is determined to have occurred, an administrator is immediately informed of the change at step S110, and a distribution policy is changed at step S112.

Next, when the vaccine database or the vaccine engine is stored, meta information about the vaccine database or the vaccine engine is collected and an MD5 hash value of the vaccine database or the vaccine engine is generated and stored so that search is facilitated at step S114.

Next, preparations for verification are made at step S116, and it is determined whether the collection of information about the vaccine database or the vaccine engine will be stopped at step S118. If, as a result of the determination, the collection of information is determined to be stopped, the process proceeds to the verification process.

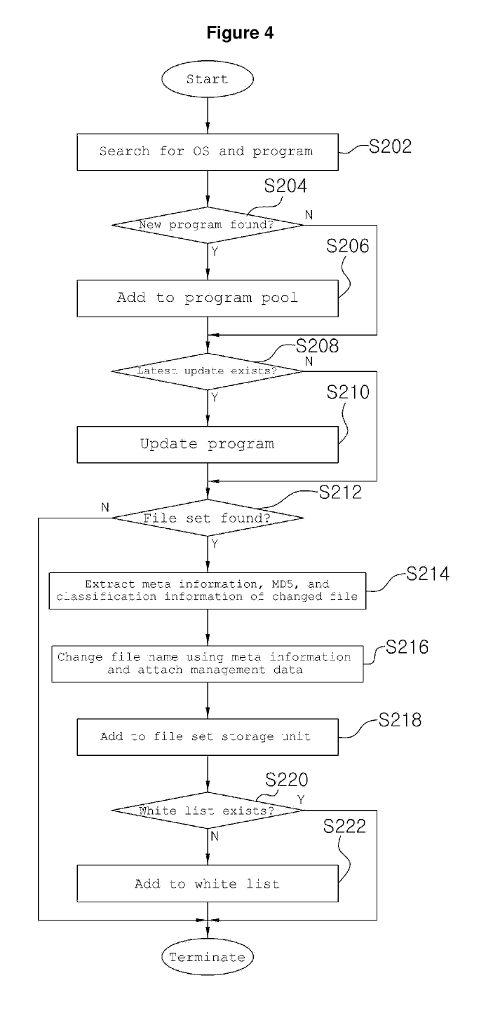

FIG. 4 is a flowchart illustrating the file set collection process.

All files of a program frequently used by a user or an operating system in which vaccine is executed are collected and stored in the form of a white list program such that normal programs can be clearly distinguished from viruses.

First, an operating system or a program to be stored in the file set storage unit 108 is searched for at step S202.

The white list program to be stored in the file set storage unit 108 is indispensable in an OS, and it chiefly includes programs downloaded from file download sites or game programs. A criterion for determining the number of downloads or the number of users may be set by the verification system 100. A necessary program may be selected by analyzing application download associated with the verification system 100 or the priority counted by sale sites.

Furthermore, a necessary program may be selected with reference to the rank of downloads or selling which is issued by file download sites. However, programs stored in the file set storage unit 108 of the present invention are not limited to only higher popularity programs. For example, programs considered to be important according to an administrator’ selection may be selected.

Furthermore, business applications or operating systems being used in the system of a company connected to the verification system 100, applications requested for error from the verification system 100, and so may also be stored in the white list program. A company that has developed various applications may request verification from the verification system 100 so that the developed applications are not mistaken as viruses. The verification of the verification system 100 is updated in a vaccine database, thereby preventing error detection.

Such verification information is included in meta information of a target test file set and used to prevent a mistake during a vaccine database update process or detection error due to the modification of a vaccine engine.

It is determined whether a new program has been found at step S204. If, as a result of the determination, the new program is determined to have been found, the new program is added to a program pool at step S206. It is determined whether there is the latest update in the added program at step S208. If, as a result of the determination, the latest update is determined to exist in the added program, the added program is updated at step S210.

It is then determined whether there is a newly added or changed file set in the programs stored in the file set storage unit 108 at step S212. If, as a result of the determination, the newly added or changed file set is determined to exist in the programs, meta information, an MD5 hash value, and classification information of a corresponding program are extracted at step S214.

A file name or data is changed on the basis of the extracted meta information and recorded on management data at step S216.

After the file set is changed, the changed file is stored in the file set storage unit 108 at step S218.

It is then determined whether a white list (that is, a list for normal programs) exists in the file set storage unit 108 at step S220. If, as a result of the determination, the white list is determined to exist in the file set storage unit 108, the corresponding program is added to the white list at step S222.

The program added to the white list is taken into consideration when a vaccine database is generated and henceforth not mistaken as a virus.

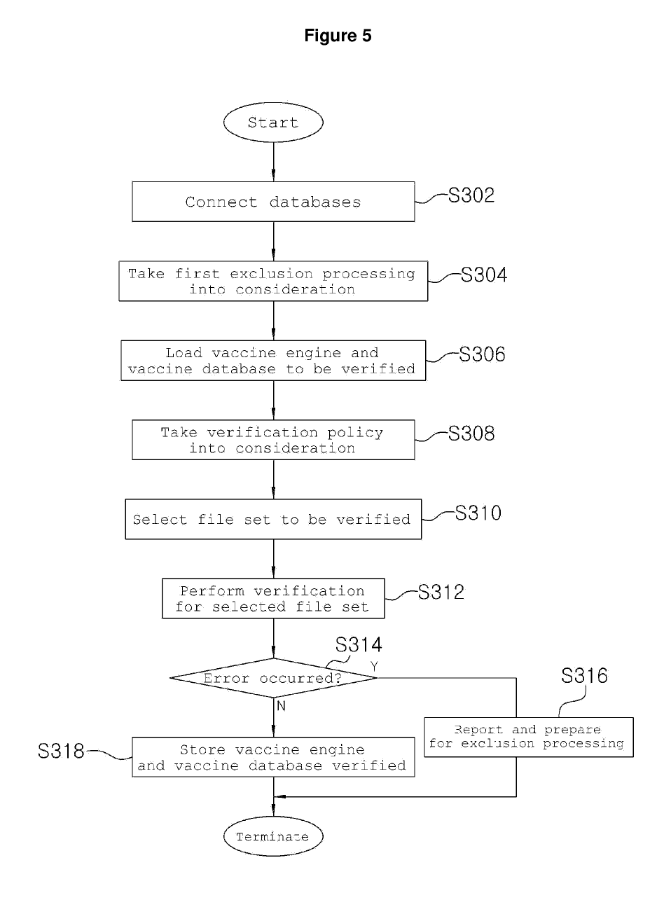

FIG. 5 is a flowchart illustrating the verification process for a vaccine engine and a vaccine database.

A load of the verification process is gradually increased because of some factors, such as the use of various applications according to an increase of vaccine users and the improvement of a network speed, an increase in the size of an application according to the improvement of the specification of a PC, and an increase in the number of file set lists to be verified according to the version up of applications and Windows.

Furthermore, a load of the verification process is increased in proportion to an increase of the number of engines used in a vaccine. A load of the verification process may lead to the delay of a verification time. In this case, the verification process is problematic in rapidly transferring a vaccine database to users.

In the verification system 100 of the present invention, verification machines are configured so that they may be dynamically increased in the verification process. In selecting verification machines to be used in the verification time, the number and range of verification machines are differently set dynamically on the basis of a predicted load of the entire system so that they comply with the schedule of a distribution process. Furthermore, a constant verification time is maintained by increasing or decreasing the number of verification machines such that verification is performed according to a schedule by intelligently determining the number of verification machines used in the verification process.

Furthermore, the entire process is operated all day in an efficient and automatic manner, thereby being capable of minimizing a problem that a vaccine database update is delayed.

In the verification process, a target test file set may be verified in the most efficient way by dynamically or statically designating a policy per file, folder, capacity, date, type, or a combination of them.

The verification unit 102 connects the first database storage unit 104 and the first engine storage unit 106 at step S302. The verification unit 102 primarily excludes a database not requiring verification at step S304. Next, the verification unit 102 loads a vaccine engine and a vaccine database which are the subject of verification at step S306.

The verification unit 102 selects a file set to be verified according to a verification policy previously set by an administrator or a system at steps S308 and S310. The verification policy may be set every cycle, program type, or field, and a new policy may be used as occasion demands.

The verification unit 102 extracts a program file set selected according to the verification policy from programs stored in the file set storage unit 108 and verifies whether error exists in a vaccine database at step S312. The verification process is performed to mount the vaccine database (that is, the subject of verification) on the vaccine engine (that is, the subject of verification) and to check whether a corresponding program is recognized as a virus while executing the program file set included in the white list.

It is then determined whether error occurs in the verification process at step S324. If, as a result of the determination, error has occurred, an administrator is informed of the fact, and the corresponding vaccine database is not distributed and excluded at step S316.

If, as a result of the determination at step S314, error has not occurred, the corresponding vaccine engine and vaccine database may be considered as being normally operated. Accordingly, preparations for distribution are made, and the corresponding vaccine engine and vaccine database are stored in the second database storage unit 110 and the second engine storage unit 112, respectively, at step S318.

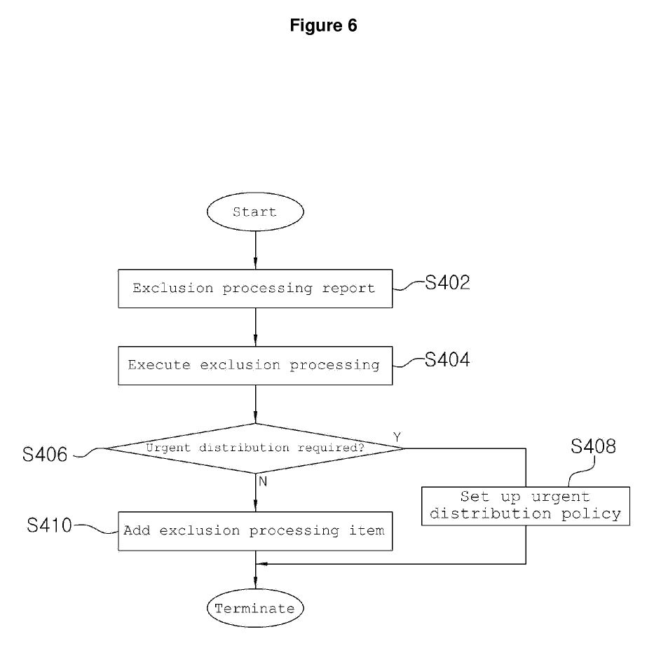

FIG. 6 is a flowchart illustrating the exclusion processing process for an engine or database with error.

The exclusion processing unit 114 may prevent the occurrence of a security accident by stopping the distribution of a vaccine database before the verification process or the distribution process. The exclusion processing process may control an automated distribution process by setting up an emergency distribution policy.

The exclusion processing unit 114 collects an exclusion processing report including information about a database having error (that is, the subject of exclusion processing) at step S402. The exclusion processing unit 114 executes proper exclusion processing on the basis of the exclusion processing report at step S404. Next, the exclusion processing unit 114 determines whether emergency distribution is required at step S406. If, as a result of the determination, emergency distribution is determined to be required, the exclusion processing unit 114 distributes the latest vaccine database according to the emergency distribution policy at step S408.

According to the present invention, a file set of the latest vaccine database can be rapidly collected and processed, and the problems of a vaccine database file provided by a vendor can be checked in advance. Accordingly, there are advantages in that a function of alarming error conditions and a process of reporting error in a vaccine database update process can be automated.

Furthermore, according to the present invention, vaccine databases for various and many programs, operating systems, and applications executable in environments in which users use PCs can be verified in advance. Accordingly, there is an advantage in that various security accidents that may occur in user computing environments can be prevented.

Furthermore, an exclusion processing process can be rapidly performed not only when a vaccine database is produced, but also before and after verification on the basis of a target test file set and after distribution. Accordingly, there are advantages in that erroneous detection and verification of a vaccine database can be checked in advance, post check and urgent countermeasure after distribution can be rapidly performed, and the general process, such as the alarm of urgent conditions, the transfer of information to an administrator, and the real-time distribution and management of a vaccine database can be automated.

Furthermore, according to the present invention, there is an advantage in that the time that it takes to perform a verification process can be optimized by intelligently setting the number of verification machines used in the verification process.

While some embodiments of the invention have been described with reference to the accompanying drawings, it will be understood that those skilled in the art can implement the technical construction of the present invention in various forms without departing from the technical spirit or indispensable characteristics of the present invention. Accordingly, the above embodiments should be construed to be illustrative and should not be limitative from all aspects. Furthermore, the scope of the present invention is defined by the appended claims rather than the above detailed description. The present invention should be construed to cover all modifications or variations induced from the meanings and scope of the appended claims and their equivalents.

What is claimed is:

1. A verification system for automatically verifying error of a vaccine database for storing information about a computer virus, a worm, or a malicious code (hereinafter generally referred to as a ‘virus’), the verification system comprising:
a first database storage unit for collecting a vaccine database to be verified and storing the collected vaccine database;
a first engine storage unit for collecting a vaccine engine to be verified and storing the collected vaccine engine;
a file set storage unit for collecting a program to be registered so that the program is not mistaken as a virus and storing the program;
a verification unit for mounting the vaccine database, stored in the first database storage unit, on the vaccine engine stored in the first engine storage unit, testing the program stored in the file set storage unit, and determining whether the program is recognized as a virus on the basis of the test;
an exclusion processing unit for, if, as a result of the determination, the program is determined to be recognized as a virus, modifying the vaccine database mounted on the vaccine engine so that the program is not recognized as a virus;
a second database storage unit for, as a result of the determination, the program is determined not to be recognized as a virus, storing the verified vaccine database; and
a second engine storage unit for, as a result of the determination, the program is determined not to be recognized as a virus, storing the verified vaccine engine.

2. The verification system as claimed in claim 1, wherein the program stored in the file set storage unit is any one of a program downloaded from a file download site, a game program, a business application being used in a company connected to the verification system, and an application requested for a check into error from the verification system.

3. The verification system as claimed in claim 1, further comprising a distribution processing unit for distributing the vaccine database and the vaccine engine, verified by the verification unit and respectively stored in the second database storage unit and the second engine storage unit, through an Internet every predetermined time and cycle.

4. The verification system as claimed in claim 3, wherein the verification unit constantly maintains a time taken for a verification process by increasing or decreasing a number of verification machines, used in a process of verifying the vaccine database, according to the time taken for the verification process.

5. A verification method of automatically verifying error of a vaccine database for storing information about a computer virus, a worm, or a malicious code (hereinafter generally referred to as a ‘virus’), the verification method comprising:
a first step of collecting a vaccine database and a vaccine engine to be verified and storing the vaccine database and the vaccine engine in a first database storage unit and a first engine storage unit, respectively;
a second step of collecting a program to be registered so that the program is not mistaken as a virus and storing the collected program in a file set storage unit;
a third step of a verification unit mounting the vaccine database, stored in the first database storage unit, on the vaccine engine stored in the first engine storage unit, testing the program stored in the file set storage unit, and determining whether the program is recognized as a virus on the basis of the test;
a fourth step of, if, as a result of the determination, the program is determined to be recognized as a virus, an exclusion processing unit modifying the vaccine database mounted on the vaccine engine so that the program is not recognized as a virus;
a fifth step of, as a result of the determination, the program is determined not to be recognized as a virus, storing the verified vaccine database in a second database storage unit; and
a sixth step of, as a result of the determination, the program is determined not to be recognized as a virus, storing the verified vaccine engine in a second engine storage unit.

6. The verification method as claimed in claim 5, wherein the program stored in the file set storage unit is any one of a program downloaded from a file download site, a game program, a business application being used in a company connected to the verification system, and an application requested for a check into error from the verification system.

7. The verification method as claimed in claim 5, further comprising a seventh step of a distribution processing unit distributing the vaccine database and the vaccine engine, verified by the verification unit and respectively stored in the second database storage unit and the second engine storage unit, through an Internet every predetermined time and cycle.

8. The verification method as claimed in claim 7, wherein:
the verification unit verifies whether the program is mistaken as a virus every cycle, and
a verification cycle of the verification unit is shorter than a distribution cycle of the distribution processing unit.
